(19) United States
(12) Patent Application Publication
(10) Pub. No.: US 2020/0152003 A1
(43) Pub. Date: May 14, 2020

(54) GAMBLING SYSTEMS AND METHODS BASED ON BLOCKCHAIN TECHNOLOGY

(71) Applicant: Thunder Token Inc., Sunnyvale, CA (US)

(72) Inventors: Marios Georgiou, New York, NY (US); Yifan Jian, Pleasanton, CA (US); Chengwen Chris Wang, Las Vegas, NV (US)

(21) Appl. No.: 16/683,170

(22) Filed: Nov. 13, 2019

Related U.S. Application Data
(60) Provisional application No. 62/760,821, filed on Nov. 13, 2018.

(51) Int. Cl. G07F 17/32; H04L 9/32; H04L 9/06; G06F 7/58

(52) U.S. Cl. CPC G07F 17/3241; G07F 17/3244; H04L 2209/38; H04L 9/0637; G06F 7/58; H04L 9/3236

(57) ABSTRACT

The present invention is directed to gambling system and methods. The systems and methods involve a commit-reveal protocol that is configured to obtain random numbers from a player computer and a casino computer and use the obtained random numbers as seed to execute a random operation of an online game such as online slot machine. The described commit-reveal protocol eliminates extra rounds of communication and ensure a fair outcome. The systems and method may be supported by a blockchain system to further ensure that the operation of the online game is not rigged or false.

### CROSS-REFERENCE TO RELATED APPLICATION(S)

This application claims the benefit of U.S. Provisional Application 62/760,821, filed Nov. 13, 2018, the entirety of which is herein incorporated by reference.

### FIELD OF THE INVENTION

The present disclosure generally relates to the field of online gaming systems and methods. More particularly, the present disclosure relates to a one-on-one online gaming system and method supported by blockchain technology.

### BACKGROUND OF THE INVENTION

One of the popular applications of the blockchain technology is on gambling games. The blockchain technology can provide fair gambling games by ensuring that the players' chances of winning cannot be biased by anyone. Blockchain-based gambling games are implemented by gambling contracts (or computer protocols) that include terms (or computer codes) that prevent someone from biasing the outcomes of the games. Players can examine the gambling contract before playing the gambling game to be certain that such terms are incorporated and that the gambling game will be fair. The gambling contract cannot be manipulated, and the computer(s) on which the gambling contract is implemented will enforce the terms and the players will play according to the enforced terms. The transactions of the gambling games are stored into a blockchain or distributed ledger. The stored transactions are trackable and irreversible. Comparing with off-chain or traditional gambling games, this approach is much more preferable. For example, players playing a slot machine in a casino or on the web do not have any guarantee that they are playing a fair game. A slot machine could be programmed to never give out the jackpot or to give the jackpot only to a specific predefined person. Using the blockchain technology, a slot machine contract that protects both the casino and the player from cheating can be implemented.

In addition to or as part of the terms that prevent someone from biasing the gambling outcome, blockchain-based gambling games generate a random number that is used to determine the gambling outcome. The random number is fed to an input of the gambling game (e.g., slot machine) and the gambling game outputs a corresponding outcome (e.g., “7,” “7,” and a cherry image). Therefore, if the number is truly random (not manipulated), then the gambling game will be fair. Generating a random number or a truly random number in applications that rely on the blockchain technology, however, is difficult. One way to obtain a random number is by using the hash of the last block or a newly mined block that is about to be added to the blockchain. In a proof-of-work blockchain system and under the assumption that miners possess only a very small fraction of the total hashing power, such an approach could possibly work. However, when a miner possesses a considerable amount of hashing power (e.g., 51% or more of the total hashing power), the miner could attempt to mine two blocks as the next block in the blockchain and then pick the one that favors it. This attack doubles the winning chance of the adversary. In a proof-of-stake blockchain system, this problem is even worse. The authorized stake-holder who gets to pick the next block can easily create several blocks without even spending a lot of computational power and thus possess a significant advantage. The Dice 2 Win protocol is based on similar concepts. In that protocol, the casino does not select and send a random number and the random number selection depends on the hash of a future block. A player may be lucky enough to be the miner and thus alter the hash of that block or produce more than one block and pick one that is more favorable to that player. Another way to obtain a random number is to use the hash of a block that is already in the blockchain. However, the hashes of all the existing blocks are already known, and adversaries and players could perform calculations to determine which hash is used and find out in advance if they win or lose.

The Rando protocol is another way to obtain a random number. That protocol, however, involves a random number generator that requires input from more than one player (non-casino individuals or computers). In the random number disclosing phase, the last player to unveil can always leave the gambling game and thus abort the entire protocol. To deal with this problem, the protocol requires each player to submit a monetary deposit in the beginning of the game. If the player attempts to terminate or leave the game before the game concludes, the player loses his or her deposit. This solution, however, incentives players to attempt DoS attacks on other players so that the other players lose their wagers or deposits.

Accordingly, there remains a need for blockchain-based gambling games that are improved over the prior art.

### SUMMARY OF THE INVENTION

In accordance with principles of the present invention, a computer-implemented method for implementing an online game is contemplated. The method comprises implementing a smart contract on a gambling system including a processor, memory configured to store computer instructions that are executable by the processor, and a network interface configured to connect the gambling system to a communications network. Execution of the smart contract causes the gambling system to communicate with a casino computer over the communications network and obtain game winning payout amounts from the casino computer; communicate with a player computer over the communications network and obtain a wager amount and a hash representing a random number selected from the player computer, wherein the random number selected from the player computer is hashed using a cryptographic hash function; communicate with the casino computer and obtain a random number from the casino computer; communicate with the casino computer and instruct the player computer to reveal the random number of the hash, and hash the revealed random number using the cryptographic hash function to produce another hash; and upon determining that the hash representing the random number selected from the player computer and the hash of the revealed random number match, use the revealed random number from the player computer and the random number from the casino computer as seed for a random operation of the online game.

In one embodiment, the online game is an online slot machine and the revealed random number from the player computer and the random number from the casino computer are used as seed for a random operation of the online slot machine.

In one embodiment, the step of hashing step is based on SHA256 technology.

In one embodiment, execution of the smart contract further causes the gambling system to executing a blockchain consensus protocol configured to produce a distributed ledger and one or more of the requested information is recorded on the distributed ledger.

In one embodiment, the random operation of the online game determines an outcome and the outcome determines whether the casino computer or the player computer wins the online game.

In one embodiment, the random number from the player computer is unknown to the gambling system until the player computer reveals the random number.

In one embodiment, the random number from the player computer and the random number from the casino computer are generated by a random number generator. The random number generator may be a generator certified by an approved testing authority or a non-certified generator.

In one embodiment, the random number requested from the casino computer is an un-hashed or raw random number. The un-hashed or raw random number from the casino computer and the revealed random number from the player computer are used as seed for a random operation of the online game.

In one embodiment, the online casino game is played by only one casino computer and one player computer.

Counterpart system and computer-readable medium embodiments are also contemplated.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 depicts an illustrative gambling system in accordance with some embodiments of the present invention;

FIG. 2 depicts steps performed by the gambling system in accordance with some embodiments of the present invention; and

FIG. 3 depicts other steps performed by the gambling system in accordance with some embodiments of the present invention.

### DETAILED DESCRIPTION OF THE INVENTION

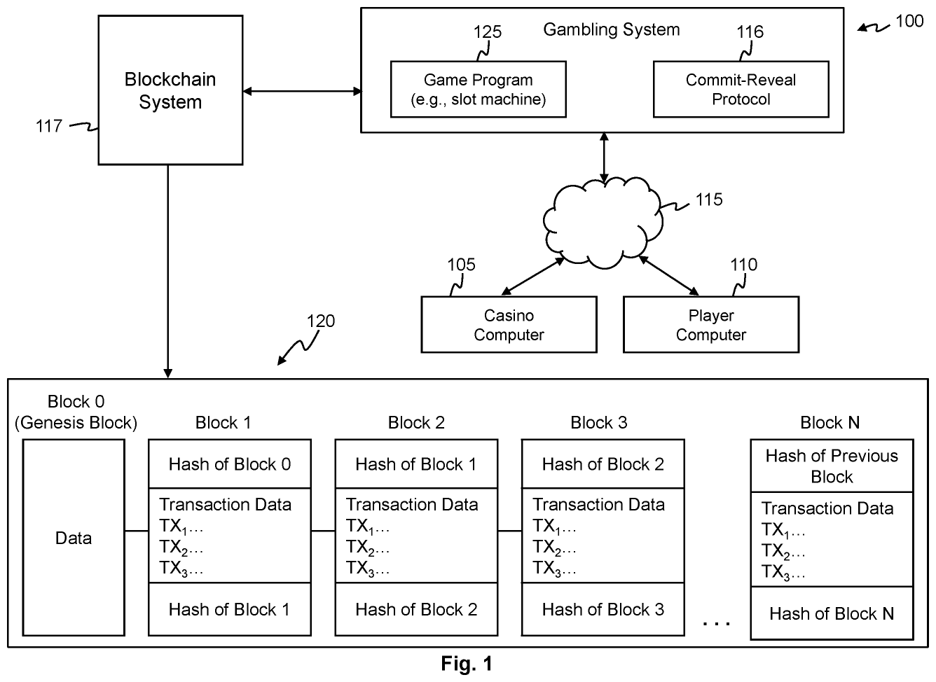

FIG. 1 depicts an illustrative gambling system 100 of the present invention. The gambling system 100 may include or be configured to communicate with a casino or house computer 105 (client terminal) and a player computer 110 (client terminal) over a communications network 115. The gambling system 100 is implemented with a commit-reveal protocol 116 configured to communicate with the casino computer 105 and the player computer 110. The gambling system 100 receives network messages or transactions (e.g., payout amounts, wager amount, random numbers, etc.) from the casino computer 105 and the player computer 110 using the commit-reveal protocol 116. The network messages, digital messages, or transactions are constructed and transmitted by computers using packets over a communications network. The gambling system 100 may be supported by a blockchain system 117 that includes a plurality of node computers and a communications network connecting the plurality of node computers. The blockchain system is implemented with a blockchain consensus protocol that is adapted to connect to the node computers through the communications network and that allow the node computers to reach a consensus and add transactions to an overall transaction record, distributed ledger, or blockchain 120 upon reaching a consensus. The gambling system 100 may add transactions in the form of blocks using the blockchain consensus protocol. The blockchain 120 is where the transactions through the gambling system 100 is stored. The gambling system 100 is also implemented with a gambling game 125, e.g., a computer program written to execute a game of chance such as slot machine, blackjack, pai gow, poker, etc.

The commit-reveal protocol 116, the computer game program 125, the blockchain consensus protocol 117, or a combination thereof may be referred to as a gambling contract, a smart contract, or computer gambling algorithms. The contract or algorithms may also include other features such as cryptographic hash function. The contract or algorithms are implemented, for example, using blockchain technology to be an immutable self-executing code. Each of the system 100 and computers includes a processor, memory storing computer instructions executable by the processor, and a network interface operatively coupled to the processor and the communications network which may be a wide area network such as the Internet.

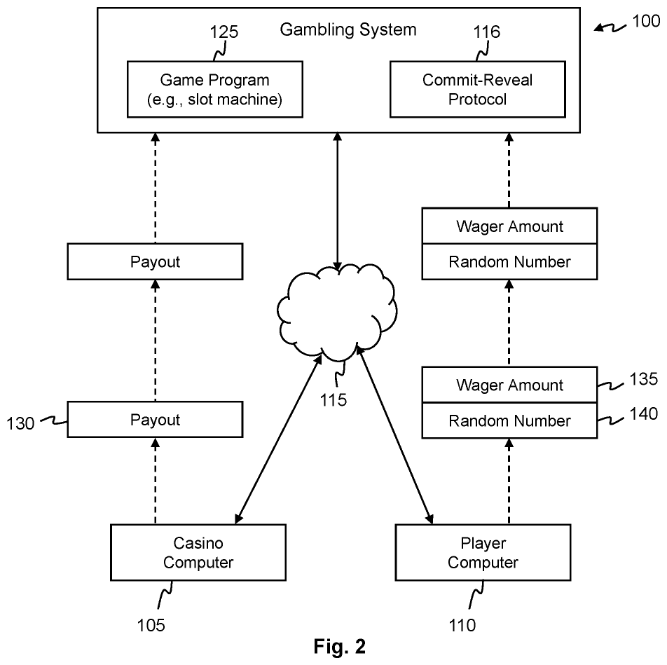

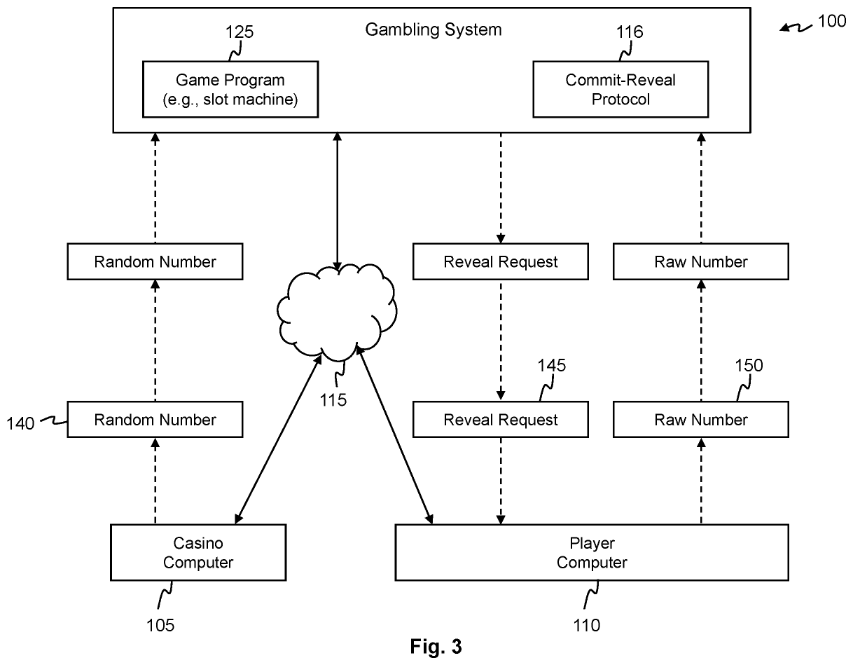

Description will now be directed to operations of the smart contact or the commit-reveal protocol 116 of the smart contact which are illustrated in FIGS. 2-3. In one embodiment, the gambling system 100 (or computer gambling algorithms) is initiated by the casino computer 105 communicating with the gambling system 100 and the casino computer 105 sending a monetary amount 130 that the gambling system 100 (or computer gambling algorithms) can pay to the player computer (or player) 110 when the player computer (or player) 110 wins. A player can join or start the gambling game from his or her computer or mobile device (generally referred to as a computer) by selecting a wager amount and a random number. The player can pick a random number by using a random number generator (RNG) provide by the gambling system 100 or a third party RNG or by simply thinking of a number. When a RNG is used, the RNG can be a certified RNG or a non-certified RNG. A certified RNG is one that has been tested and approved by a RNG testing authority. In general, the results produced by a certified RNG have to be unpredictable, non-repeatable, and uniformly distributed. After certification, the computer codes in the RNG cannot be changed. A non-certified RNG may or may not have such properties (e.g., unpredictability, non-repeatability, and/or uniform distribution) and the computer codes in the RNG can still be modified. The random number is then hashed using a cryptographic hash function before it is transmitted. The hash cryptographic hash function may be SHA-2, SHA256, SHA3-256, or other hash functions and is one very difficult for the casino computer 105 to invert to determine the random number. The objective being that even if the casino computer 105 detects the hashed version of the random number selected by the player, the casino computer 105 will not be able to apply a process to figure out the selected random number itself. The player computer 110 may not be able to change the selected random number once it is hashed. The gambling system 100 stores the hashed random number or a copy of the hashed random number. In some embodiments, the gambling system 100 receives or stores the hashed random number or a copy of it, but not the raw random number from which the hash is derived. The gambling system 100 may not know the raw random number until the player computer 110 reveals at a later time (discussed below). The wager amount 135 and the hashed random number 140 can be transmitted to the gambling system 100 simultaneously or at different times.

Next, the casino computer 105 selects and sends a random number 140 to the gambling system 100. Like the player computer 110, the casino computer 105 can also select a random number by using the RNG provided by the gambling system 100 or a third party RNG or by simply thinking of a number. The casino computer 105 does not need to commit the selected random number and can send the random number in the clear (e.g., sending the selected random as is, without hashing it). The gambling system 100 then requests 145 the player computer 110 to send or reveal the actual selected random number 150 (the random number before being hashed or un-hashed or raw random number). After receiving the actual random number 150, the gambling system 100 can verify whether the player computer 110 sent the correct random number by using the same cryptographic hash function to hash the received random number. If the resulting hash is the same the hash stored on the gambling system 100 (the hash previously obtained from the player computer), then the gambling system 100 knows that the player computer 110 submitted the correct random number. If the player computer 110 does not send the correct random number (e.g., inadvertently send the wrong number or attempt to cheat the gambling system), the gambling system 100 may not proceed to the next step until the correct random number is received. The cryptographic hash function is very difficult, if not impossible, to invert or solve (e.g., using another number that can produce the same hash or solving the hash to determine the random number behind the hash). After the player computer 110 reveals the actual random number, the casino computer 105 is prevented from changing the random number the casino computer 105 submitted. In some embodiments, a bot or similar software or network device is implemented that automatically performs the reveal step on behalf of the player. The bot can be part of the player computer or could be external to the player computer. The bot would automatically send the random number selected by the player (un-hashed or raw random number) to the gambling system.

The gambling system 100 then uses the random number (un-hashed or raw random number) from the casino computer 105 and the random number (un-hashed, raw, or revealed random number) from the player computer 110 to perform the gambling game or use them as a seed for the random operation of the gambling game (e.g., a slot machine configured to have certain odds that uses the random number(s) as a seed for its random operation). The outcome of the random operation then determines who wins the gambling game. The monetary amount submitted by one participant (e.g., casino) is transferred to the other participant or the other participant's account (e.g., player). The gambling system 100 can display or provide the outcome, the monetary transfer, or other transaction information to the participants (casino and player) on the display of their corresponding computer to allow the participants to verify the outcome, the monetary transfer, or other transaction information.

In some embodiments, the gambling system 100 may use only one of the random numbers as the seed. The random number selected by the casino computer 105 or the player computer 110 may be referred to as secret. The casino computer 105 may be referred to as a first computer operated by a casino, an entity, or individual who wishes to be the dealer, casino, or house of the gambling game or configured to perform the operations discussed with respect to the casino computer 105. The player computer 110 may be referred to as a second computer operated by an entity or individual who wishes to be a player or gambler of the gambling game or configured to perform the operations discussed with respect to the player computer 115.

The gambling system or computer gambling algorithms described in this application can protect against fraud or cheating because the player would not be able to change the selected random number after the hashed random number is sent and the casino cannot change its random number after the player reveals his or her random number. The use of the combination of the two numbers or a number based on them to provide the seed for the random operation of the gambling system also provide additional protections to have a fair outcome. Moreover, compared to the Rando protocol, embodiments of the present invention can eliminate the need to request an initial deposit from the players (eliminates one round of communication). If a player decides to leave the game (e.g., because he or she knows if they win or lose after the casino sends its random number in the clear), the player would lose his or her wager. The arbitrary abortion prevention mechanism is built into the wager itself or the message submitted to the gambling system that includes the wager amount and random number.

Embodiments of the present invention also eliminate the need for the casino to commit to its submitted random number (eliminates one or more rounds of communication and operation). The casino sends its random number in the clear (un-hashed or raw random number) and thus does not require hashing and the casino subsequently revealing its random number for verification. A commitment (or commitment and reveal process) is a process in which a party or computer commits to the information (e.g., random number) it submits and that prevents the party or computer from later changing the submitted information. For example, if the casino were required to commit to its random number, then the random number is hashed and the hashed random number is stored on the gambling system. Subsequently, the casino is required to send the un-hashed or raw random number and only the correct un-hashed or raw random number would be accepted by the gambling system (or produce the same hash when the same hash function is used). The party or computer is committed because it is required to send the correct random number at a later time. In one embodiment of the present invention, the casino computer does not perform a commitment process and the player performs a commitment process.

In other words, a commitment is a process that allows a party (or participant) to make a commitment to a certain value and reveal it with verifiability at a later point in time. This is used for making sure that the issuer of the commitment does not change the committed value at the time of revelation. A simple commitment scheme may involve publishing the cryptographic hash of the value committed. To verify, one only needs to compute the cryptographic hash of the revealed value and check it against the hash value published earlier by the issuer of the commitment.

Embodiments of the present invention also provide more options in selecting random numbers. Participants (player and casino) can use a certified RNG or non-certified RNG or enter any number they wish. In contrast, some existing systems only allow using certified RNGs which can increase implementation cost and system complexity. As such, embodiments of the present invention do not require certification by an approved authority or using certified tools. Certification, in some embodiments, refers to a process where trust or certain performance can be established or achieved and certificates are issued to sites or providers that implement that process. The random numbers can also be automatically generated by the player computer and the casino computer and transmitted without requiring individual or corresponding users to select numbers (without knowledge or involvement by the casino or player). For example, when the gambling game is a slot machine, the player may use click “play/spin” and the smart contract automatically performs the random number generation process. Additionally, embodiments of the present invention do not require players who are guaranteed that they would reveal (trusted players). In some embodiments, the smart contact provides trust and the features of the smart contract that provide trust are particularly valuable, such as the recordation of transactions in connection with the smart contact on a blockchain as described in more detail herein. A bot can be implemented to automatically reveal for the player. Furthermore, in one-on-one implementations of the present invention, the participants do not have incentive to collude or cheat the gambling system together because they are adversarial.

Testing of the technology has also shown that it can operate to provide quick operation of the game (within a second or less) and saves computational power. A single game can complete within about 10 blocks in the blockchain (e.g., from the moment the casino submits payout amounts to the moment the gambling system determines who wins the game).

The gambling system can be further configured to have a feature (e.g., CasinoStatus variable) that determines when the casino computer can cash out. The casino computer can withdraw winning (e.g., wager amount from the player) only at specific determined times. A player who is afraid of the casino withdrawing a payout just before the player wins can play only during the period when the payout is locked.

The gambling system can be further configured to introduce a deadline after which the player cannot reveal his or her raw random number and loses his or her wager. This allow the player computer from the same address or IP address to play the game again in the future even if it did not reveal.

Embodiments of the present invention involve a digital signature scheme using public key-private key cryptography. The digital signature allows a party (or participant) to digitally sign a message, so that the receiving parties (or receiving participants) can be sure about the origin of the message, and at the same time enforces non-refutability on the signing party. It works by a pair of digital keys such as public key and private key. The private key is kept secret by the signing party and used for signing the messages. The public key is broadcast to the receiving parties which may verify about the origin of a signed message upon receiving.

In some embodiments, in the commit-reveal protocol, the role or position of the casino and the player can be swapped. The casino can commit and reveal and the player can send the random number in the clear. The gambling system can further have penalty or reputation rules to disincentive participants from performing DoS attacks or other attacks.

Embodiments of the present invention are directed to online games. Embodiments of the present invention are preferably directed to one-on-one online games, i.e., a game between a player and another player or between a player and the casino (in each case it is possible for the counter party that is playing to be a computer that takes automated actions in the game as the counter-party such as when a casino automates its operations). The games can also be played between a casino and multiple players simultaneously (e.g., casino vs. player 1, casino vs. player 2, etc.) but the result or operation of each process is independent of another. Other variations or combinations are also contemplated. In some embodiments, the technology is also applicable to non-gambling online games (e.g., online video games, online board games, etc.) that require fairness or that can ensure an outcome that is random or close to random as possible and is not controlled or manipulated by the casino or some other parties. The system provides a systematic level of operational integrity that prevents cheating or unfair manipulation of the outcome or process by another party such as the casino.

In some embodiments, the technologies are also applicable to gambling games that involve multiple players, such as a game between three or more players (e.g., poker, Texas hold'em, etc.) or a game between two or more players and the casino.

Although the technologies in this application are described from a system perspective, counterpart method and computer-readable medium embodiments are also understood from the above disclosure.

The use of blockchain to support the gambling system ensures in a verifiable way that the operation of the game is not rigged or false/manipulated, e.g., the blockchain records the activity which protects against manipulation of the data (the operation) by using the blockchain technique where the hash of successive blocks rely on the content of the current and a past block. In some embodiments, however, the smart contract can also be implemented on a server or a centralized manner (e.g., storing all the transactions or communications to and from the smart contract in the server).

A block refers to a block on a blockchain or a block to be added onto a blockchain so that it extends from the latest block from a blockchain. A block may include transactions, hash of the previous electronic block, hash of the current electronic block, a timestamp, Merkle root, target, nonce, and other information, or one or more of the aforementioned information.

Transactions or transaction data may include casino's payout and random number, player's wager, random number, hashed random number, revealed random number, or a combination thereof. Transactions or transaction data may include cryptocurrency transactions (e.g., Bitcoin transactions), bank transactions, credit card transactions, and other transactions that involve paper money (e.g., an individual can obtain paper money from a bank). For example, the casino's payout and the player's wager may be cryptocurrency. Transactions or transaction data may also be non-currency or non-monetary transactions, transactions used to create and call smart contracts, or other transactions used to perform other tasks. Transactions or transaction data may also be other types of data (e.g., computer instructions) or records (e.g., business records, medical records).

Combinations of the aforementioned transactions, data, and records are also contemplated. A cryptographic hash function is a function which takes an input of any size and outputs a non-revertible fixed length string. That is, given an output it is not feasible to find a corresponding input which would lead to the output under the application of the cryptographic hash, for example, SHA-256.

Protocols and algorithms described in this application are implemented on computers or node computers that are connected by a communications network. The communications network can include the Internet, a cellular network, a telephone network, a computer network, a packet switching network, a wide area network (WAN), a global area network, or other network. It is understood from FIGS. 2 and 3 that the network messages 130, 135, 140, 145, 150 are transmitted through the communications network 115. Embodiments of the present invention are directed to systems, devices, and methods that perform the protocols and algorithms. Embodiments of the present invention are also related to a non-transient computer readable medium configured to carry out any one of the methods disclosed herein. The protocols and algorithms can be a set of computer instructions readable by a processor and stored on the non-transient computer readable medium. Such medium may be permanent or semi-permanent memory such as hard drive, optical disk, flash memory, ROM, EPROM, EEPROM, etc., as would be known to those of ordinary skill in the art. Block or information in the block or blockchain may be stored on the non-transient computer readable medium or the memory. Memory, for example, may be cache memory, semi-permanent memory such as RAM, and/or one or more types of memory used for temporarily storing data.

Processor may include an application specific integrated circuit (ASIC), programmable logic array (PLA), digital signal processor (DSP), field programmable gate array (FPGA), or any other integrated circuit. Processor can also include one or more of any other applicable processors, such as a system-on-a-chip that combines one or more of a CPU, an application processor, and memory, or a reduced instruction set computing (RISC) processor.

A computer or client terminal can be a desktop computer, laptop computer, a mobile computer, a tablet computer, a cellular device, a smartphone, a personal digital assistant (PDA), or any other computing devices having a processor and memory. A server may also be based on one of the aforementioned devices or one or more computing devices having a processor and memory. Server means a communication-oriented computer, usually with fast internal clock, large memory, and large storage capacity compared to those of a client terminal, and general capability of sustaining concurrent data communication with multiple end users or client terminals.

It is understood that embodiments of the present invention are computer-implemented systems or processes.

For the sake of brevity, not all the distinguishing points have been raised and only certain features are discussed as examples. Other differences may be understood from the present disclosure and the specification of the respective prior art reference.

It will readily be understood by one having ordinary skill in the relevant art that the present invention has broad utility and application. Other embodiments may be discussed for additional illustrative purposes in providing a full and enabling disclosure of the present invention.

Moreover, many embodiments such as adaptations, variations, modifications, and equivalent arrangements will be implicitly disclosed by the embodiments described herein and fall within the scope of the present invention.

Accordingly, while the embodiments of the present invention are described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended nor is to be construed to limit the scope of patent protection afforded by the present invention, which scope is to be defined by the claims (to be drafted based on the disclosure) and the equivalents thereof. It is not intended that the scope of patent protection afforded the present invention be defined by reading into any claim a limitation found herein that does not explicitly appear in the claim itself.

Thus for example any sequence(s) and/or temporal order of steps of various processes or methods (or sequence of system connections or operation) that are described herein are illustrative and should not be interpreted as being restrictive. Accordingly, it should be understood that although steps of various processes or methods (or connections or sequence of operations) may be shown and described as being in a sequence or temporal order, but they are not necessarily limited to being carried out in any particular sequence or order. Other sequences or temporal order is contemplated and would be understood to exist by those of ordinary skill in the art. In addition, systems or features described herein are understood to include variations in which features are removed, reordered, or combined in a different way.

Additionally, it is important to note that each term used herein refers to that which the ordinary artisan would understand such term to mean based on the contextual use of such term herein. It would be understood that terms that have component modifiers are intended to communicate the modifier as a qualifier characterizing the element, step, system, or component under discussion.

The words “may” and “can” are used in the present description to indicate that this is one embodiment but the description should not be understood to be the only embodiment.

Although the present invention has been described and illustrated herein with referred to preferred embodiments, it will be apparent to those of ordinary skill in the art that other embodiments may perform similar functions and/or achieve like results. Thus it should be understood that various features and aspects of the disclosed embodiments can be combined with or substituted for one another in order to form varying modes of the disclosed invention.

What is claimed is:

1. A computer-implemented method for implementing an online game comprising:
implementing a smart contract on a gambling system including a processor, memory configured to store computer instructions that are executable by the processor, and a network interface configured to connect the gambling system to a communications network, wherein executing the smart contract causes the gambling system to:
communicate with a casino computer over the communications network and obtain game winning payout amounts from the casino computer;
communicate with a player computer over the communications network and obtain a wager amount and a hash representing a random number selected from the player computer, wherein the random number selected from the player computer is hashed using a cryptographic hash function;
communicate with the casino computer and obtain a random number from the casino computer;
communicate with the casino computer and instruct the player computer to reveal the random number of the hash, and hash the revealed random number using the cryptographic hash function to produce another hash; and
upon determining that the hash representing the random number selected from the player computer and the hash of the revealed random number match, use the revealed random number from the player computer and the random number from the casino computer as seed for a random operation of the online game.

2. The method of claim 1, wherein the online game is an online slot machine and the revealed random number from the player computer and the random number from the casino computer are used as seed for a random operation of the online slot machine.

3. The method of claim 1, wherein the step of hashing step is based on SHA256 technology.

4. The method of claim 1, further comprising providing a blockchain consensus protocol configured to produce a distributed ledger and one or more of the requested information is recorded on the distributed ledger.

5. The method of claim 1, wherein the random operation of the online game determines an outcome and the outcome determines whether the casino computer or the player computer wins the online game.

6. The method of claim 1, wherein the random number from the player computer is unknown to the gambling system until the player computer reveals the random number.

7. The method of claim 1, wherein the random number from the player computer and the random number from the casino computer are generated by a random number generator.

8. The method of claim 7, wherein the random number generator is a generator certified by an approved testing authority.

9. The method of claim 7, wherein the random number generator is a non-certified generator.

10. The method of claim 1, wherein the random number requested from the casino computer is an un-hashed or raw random number.

11. The method of claim 10, wherein the un-hashed or raw random number from the casino computer and the revealed random number from the player computer are used as seed for a random operation of the online game.

12. The method of claim 1, wherein the online casino game is played by only one casino computer and one player computer.

13. A system comprising:
a gambling system including a processor, memory storing computer instructions that are executable by the processor, and a network interface configured to connect the gambling system to a communications network, wherein executing the computer instructions causes the gambling system to:
communicate with a casino computer over the communications network and obtain game winning payout amounts from the casino computer;
communicate with a player computer over the communications network and obtain a wager amount and a hash representing a random number selected from the player computer, wherein the random number selected from the player computer is hashed using a cryptographic hash function;
communicate with the casino computer and obtain a random number from the casino computer;
communicate with the casino computer and instruct the player computer to reveal the random number of the hash, and hash the revealed random number using the cryptographic hash function to produce another hash; and
upon determining that the hash representing the random number selected from the player computer and the hash of the revealed random number match, use the revealed random number from the player computer and the random number from the casino computer as seed for a random operation of the online game.

14. The system of claim 13, wherein the online game is an online slot machine and the revealed random number from the player computer and the random number from the casino computer are used as seed for a random operation of the online slot machine.

15. The system of claim 13, further comprising a blockchain system configured to produce a distributed ledger and one or more of the requested information is recorded on the distributed ledger.

16. The system of claim 13, wherein the random number from the player computer is unknown to the gambling system until the player computer reveals the random number.

17. The system of claim 13, wherein the random number requested from the casino computer is an un-hashed or raw random number.

18. A non-transitory computer readable medium storing computer instructions executable by a processor of a computer to perform a process, the computer further including memory configured to store computer instructions and a network interface configured to connect the computer to a communications network, wherein the process comprising:
communicating with a casino computer over the communications network and obtaining game winning payout amounts from the casino computer;
communicating with a player computer over the communications network and obtaining a wager amount and a hash representing a random number selected from the player computer, wherein the random number selected from the player computer is hashed using a cryptographic hash function;
communicating with the casino computer and obtaining a random number from the casino computer;
communicating with the casino computer and instructing the player computer to reveal the random number of the hash, and hashing the revealed random number using the cryptographic hash function to produce another hash; and
upon determining that the hash representing the random number selected from the player computer and the hash of the revealed random number match, using the revealed random number from the player computer and the random number from the casino computer as seed for a random operation of the online game.

19. The computer readable medium of claim 18, wherein the online game is an online slot machine and the revealed random number from the player computer and the random number from the casino computer are used as seed for a random operation of the online slot machine.

20. The computer readable medium of claim 18, wherein the random number from the player computer is unknown to the gambling system until the player computer reveals the random number.
